(19) United States
(12) Patent Application Publication
(10) Pub. No.: US 2024/0390716 A1
(43) Pub. Date: Nov. 28, 2024

(54) PINNED TORQUE BOX

(71) Applicant: Oshkosh Corporation, Oshkosh, WI (US)

(72) Inventor: Eric Betz, Clintonville, WI (US)

(73) Assignee: Oshkosh Corporation, Oshkosh, WI (US)

(21) Appl. No.: 18/671,379

(22) Filed: May 22, 2024

Related U.S. Application Data
(60) Provisional application No. 63/468,639, filed on May 24, 2023.
(60) Provisional application No. 63/551,221, filed on Feb. 8, 2024.

(51) Int. Cl. A62C 27/00; B66F 11/04

(52) U.S. Cl. CPC A62C 27/00; B66F 11/044

(57) ABSTRACT

A fire apparatus includes a first frame rail, a second frame rail, a torque box, a first mounting assembly coupled to a first end of the torque box, a second mounting assembly coupled to an opposing second end of the torque box, a first plurality of pins, and a second plurality of pins. The first mounting assembly includes a first mount coupled to a first side of the torque box and a second mount coupled to an opposing second side of the torque box. The second mounting assembly includes a third mount coupled to the first side and a fourth mount coupled to the opposing second side. The first pins extend through the first frame rail and the first mount, and the second frame rail and the second mount. The second pins extend through the first frame rail and the third mount, and the second frame rail and the fourth mount.

### CROSS-REFERENCE TO RELATED PATENT APPLICATION

This application claims the benefit of and priority to U.S. Provisional Patent Application No. 63/468,639, filed May 24, 2023, and U.S. Provisional Patent Application No. 63/551,221, filed Feb. 8, 2024, which are incorporated herein by reference in their entireties.

### BACKGROUND

Fire apparatuses may be configured as rear-mount aerial fire apparatuses or mid-mount aerial fire apparatuses including an aerial ladder. The aerial ladder may be rotatably coupled to a torque box. The connection between the torque box and the chassis may require periodic inspection to ensure that the connection is satisfactory. However, a complex coupling interface between the torque box and a fire apparatus frame may make maintenance and inspection difficult and time intensive.

### SUMMARY

One embodiment relates to a fire apparatus. The fire apparatus includes a chassis, a torque box disposed along the chassis, an aerial assembly supported by the torque box, a first mounting assembly coupled to a first end of the torque box, a second mounting assembly coupled to an opposing second end of the torque box, a first plurality of pins, and a second plurality of pins. The chassis includes a first frame rail and a second frame rail. Each frame rail of the first frame rail and the second frame rail defines one or more first apertures and one or more second apertures. The first mounting assembly includes a first mount coupled to a first side of the torque box and a second mount coupled to an opposing second side of the torque box. Each of the first mount and the second mount define one or more third apertures. The one or more third apertures are positioned to align with the one or more first apertures. The second mounting assembly includes a third mount coupled to the first side of the torque box and a fourth mount coupled to the opposing second side of the torque box. Each of the third mount and the fourth mount defines one or more fourth apertures. The one or more fourth apertures are positioned to align with the one or more second apertures. The first plurality of pins extend through (a) the one or more first apertures of the first frame rail and the one or more third apertures of the first mount and (b) the one or more first apertures of the second frame rail and the one or more third apertures of the second mount. The second plurality of pins extend through (a) the one or more second apertures of the first frame rail and the one or more fourth apertures of the third mount and (b) the one or more second apertures of the second frame rail and the one or more fourth apertures of the fourth mount.

Another embodiment relates to a fire apparatus. The fire apparatus includes a chassis, a torque box disposed along the chassis, an arial assembly supported by the torque box, a first mounting assembly positioned proximate to a first end of the torque box, a second mounting assembly positioned proximate to an opposing second end of the torque box, a first pinned connection, a second pinned connection, a third pin connection, and a fourth pinned connection. The chassis includes a first frame rail and a second frame rail. The first mounting assembly includes a first mount coupled to a first side of the torque box and a second mount coupled to an opposing second side of the torque box. The second mounting assembly includes a third mount coupled to the first side of the torque box and a fourth mount coupled to the opposing second side of the torque box. The first pinned connection couples the first frame rail and the first mount. The second pinned connection couples the second frame rail and the second mount. The third pinned connection couples the first frame rail and the third mount. The fourth pinned connection couples the second frame rail and the fourth mount.

Still another embodiment relates to a chassis for a fire apparatus. The chassis includes a first frame rail defining a first aperture, a second frame rail defining a second aperture, and a torque box assembly disposed along the first frame rail and the second frame rail. The torque box assembly includes a torque box and a mounting assembly releasably coupling the torque box to the first frame rail and the second frame rail. The mounting assembly includes a first plate defining a third aperture, a second plate spaced from the first plate and defining a fourth aperture, a third plate defining a fifth aperture, a fourth plate spaced from the third plate and defining a sixth aperture, a first pinned connection engaging with the first aperture, the third aperture, and the fourth aperture, and a second pinned connection engaging with the second aperture, the fifth aperture, and the sixth aperture.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a left side view of a mid-mount fire apparatus, according to an exemplary embodiment.

FIG. 2 is a bottom view of the mid-mount fire apparatus of FIG. 1, according to an exemplary embodiment.

FIG. 3 is a detailed rear perspective view of a rear assembly of the mid-mount fire apparatus of FIG. 1 without a ladder assembly, according to an exemplary embodiment.

FIG. 4 is a perspective view of a ladder support assembly including a torque box of the mid-mount fire apparatus of FIG. 1, according to an exemplary embodiment.

FIG. 5 is a front perspective view of a rear-mount fire apparatus, according to an exemplary embodiment.

FIG. 6 is a detailed front perspective view of a ladder support assembly including a torque box and a ladder assembly of the rear-mount fire apparatus of FIG. 5, according to an exemplary embodiment.

FIG. 7 is a detailed side view of the torque box of the mid-mount fire apparatus of FIG. 1 and/or the rear-mount fire apparatus of FIG. 5, according to an exemplary embodiment.

FIG. 8 is a detailed bottom perspective view of a first end of the torque box of FIG. 7, according to an exemplary embodiment.

FIG. 9 is a detailed bottom perspective view of a second end of the torque box of FIG. 7, according to an exemplary embodiment.

FIG. 10 is a detailed side view of the torque box of the mid-mount fire apparatus of FIG. 1 and/or the rear-mount fire apparatus of FIG. 5, according to another exemplary embodiment.

FIG. 11 is a detailed bottom perspective view of a first end of the torque box of FIG. 12, according to an exemplary embodiment.

FIG. 12 is a cross-section view of a portion of the torque box of FIG. 7 or FIG. 10, according to an exemplary embodiment.

FIG. 13 is a cross-section view of a portion of the torque box of FIG. 7 or FIG. 10, according to another exemplary embodiment.

FIG. 14 is a cross-section view of a portion of the torque box of FIG. 7 or FIG. 10, according to another exemplary embodiment.

FIG. 15 is a cross-section view of a portion of the torque box of FIG. 7 or FIG. 10, according to an exemplary embodiment.

FIG. 16 is a cross-section view of a mounting pin of the torque box of FIG. 7 or FIG. 10, according to another exemplary embodiment.

FIG. 17 is a cross-section view of a mounting pin of the torque box of FIG. 7 or FIG. 10, according to another exemplary embodiment.

FIG. 18 is a cross-section view of a mounting pin of the torque box of FIG. 7 or FIG. 10, according to another exemplary embodiment.

FIG. 19 is a cross-section view of a mounting pin of the torque box of FIG. 7 or FIG. 10, according to another exemplary embodiment.

FIG. 20 is a cross-section view of a mounting pin of the torque box of FIG. 7 or FIG. 10, according to another exemplary embodiment.

FIG. 21 is a cross-section view of a portion of the torque box of FIG. 7 or FIG. 10, according to another exemplary embodiment.

FIG. 22 is a cross-section view of a portion of the torque box of FIG. 7 or FIG. 10, according to another exemplary embodiment.

FIG. 23 is a cross-section view of a portion of the torque box of FIG. 7 or FIG. 10, according to another exemplary embodiment.

FIG. 24 is a cross-section view of a portion of the torque box of FIG. 7 or FIG. 10, according to another exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a fire apparatus includes a chassis, a torque box releasably coupled to the chassis, a pedestal coupled to the torque box, and an aerial assembly rotatably coupled to the pedestal. The torque box is releasably coupled to the chassis at first interfaces proximate a first end of the torque box and at second interfaces proximate an opposing second end of the torque box. Each of the first interfaces includes one or more first apertures defined by the chassis and one or more second apertures defined by a first mount coupled to the torque box. Each of the second interfaces includes one or more third apertures defined by the chassis and one or more fourth apertures defined by a second mount coupled to the torque box. A plurality of pins engage with (a) the first apertures and the second apertures and (b) the third apertures and the fourth apertures. The plurality of pins may have the same cross-sectional shape or varied cross-sectional shapes.

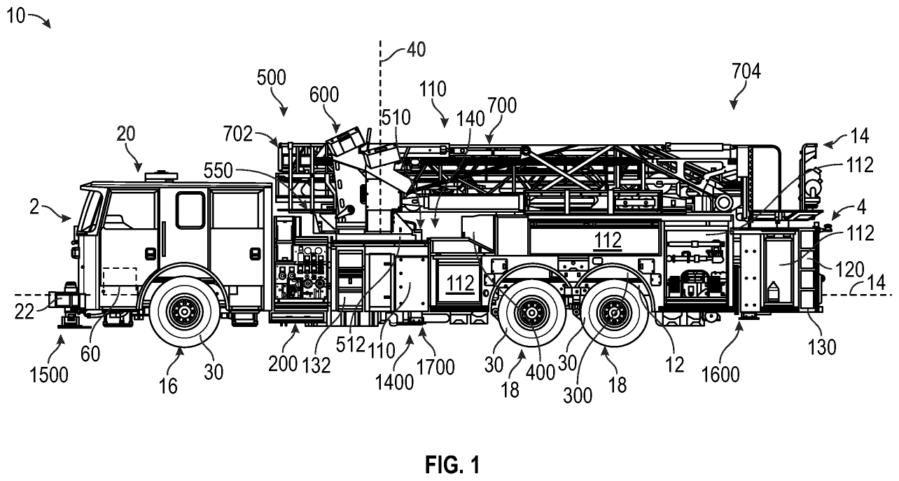

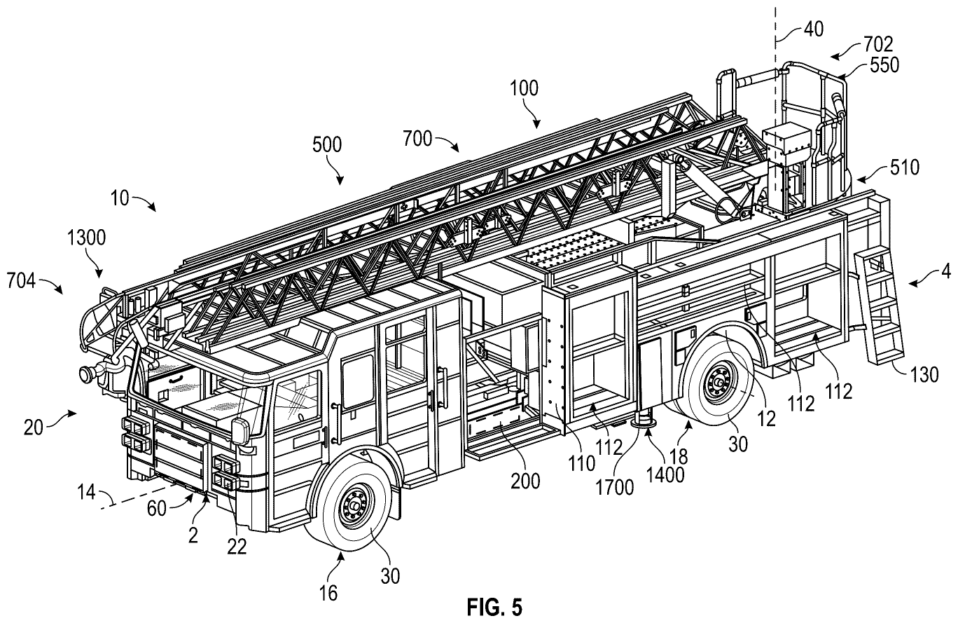

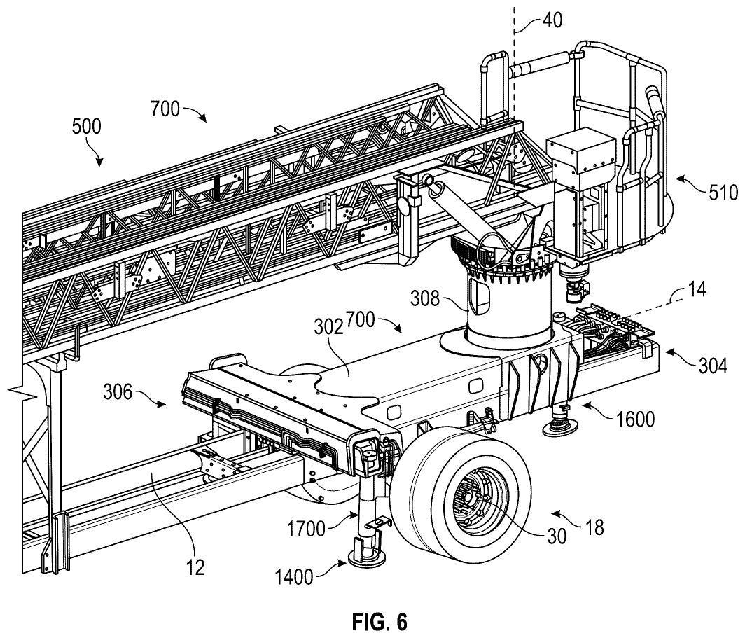

According to the exemplary embodiment shown in FIGS. 1-3, 5, and 6, a vehicle, shown as fire apparatus 10, is configured as an aerial fire apparatus. As shown in FIGS. 1-3, the fire apparatus 10 is configured as a mid-mount aerial fire truck having a tandem rear axle. In other embodiments, the mid-mount aerial fire truck has a single rear axle. As shown in FIGS. 5 and 6, the fire apparatus 10 is configured as a rear-mount aerial fire truck having a single rear axle. In other embodiments, the rear-mount aerial fire truck has a tandem rear axle. A tandem rear axle may include two solid axle configurations or may include two pairs of axles (e.g., two pairs of half shafts, etc.) each having a set of constant velocity joints and coupling two differentials to two pairs of hub assemblies. A single rear axle chassis may include one solid axle configuration or may include one pair of axles each having a set of constant velocity joints and coupling a differential to a pair of hub assemblies, according to various alternative embodiments. In some embodiments, the fire apparatus 10 is a quint fire truck. As used herein, “quint” may refer to a fire truck that includes a water tank, an aerial ladder, hose storage, ground ladder storage, and a water pump. In some embodiments, the fire apparatus 10 is configured as a non-quint mid-mount or rear-mount fire truck having a single rear axle or a tandem rear axle.

As shown in FIGS. 1-3 and 5, the fire apparatus 10 includes a chassis, shown as frame 12, having longitudinal frame rails that define an axis, shown as longitudinal axis 14, that extends between a first end, shown as front end 2, and an opposing second end, shown as rear end 4, of the fire apparatus 10; a first axle, shown as front axle 16, coupled to the frame 12; one or more second axles, shown as rear axles 18, coupled to the frame 12; a first assembly, shown as front cabin 20, coupled to and supported by the frame 12 and having a bumper, shown as front bumper 22; a prime mover, shown as engine 60, coupled to and supported by the frame 12; and a second assembly, shown as rear assembly 100, coupled to and supported by the frame 12.

As shown in FIGS. 1-3, 5, and 6, the front axle 16 and the rear axles 18 include tractive assemblies, shown as wheel and tire assemblies 30. As shown in FIGS. 1, 2, and 5, the front cabin 20 is positioned forward of the rear assembly 100 (e.g., with respect to a forward direction of travel for the fire apparatus 10 along the longitudinal axis 14, etc.). According to an alternative embodiment, the cab assembly may be positioned behind the rear assembly 100 (e.g., with respect to a forward direction of travel for the fire apparatus 10 along the longitudinal axis 14, etc.). The cab assembly may be positioned behind the rear assembly 100 on, by way of example, a rear tiller fire apparatus. In some embodiments, the fire apparatus 10 is a ladder truck with a forward portion that includes the front cabin 20 pivotally coupled to a rearward portion that includes the rear assembly 100.

According to an exemplary embodiment, the engine 60 receives fuel (e.g., gasoline, diesel, etc.) from a fuel tank and combusts the fuel to generate mechanical energy. A transmission receives the mechanical energy and provides an output to a drive shaft. The rotating drive shaft is received by a differential, which conveys the rotational energy of the drive shaft to a final drive (e.g., the front axle 16, the rear axles 18, the wheel and tire assemblies 30, etc.). The final drive then propels or moves the fire apparatus 10. According to an exemplary embodiment, the engine 60 is a compression-ignition internal combustion engine that utilizes diesel fuel. In alternative embodiments, the engine 60 is another type of prime mover (e.g., a spark-ignition engine, a fuel cell, an electric motor, etc.) that is otherwise powered (e.g., with gasoline, compressed natural gas, propane, hydrogen, electricity, etc.).

As shown in FIGS. 1-3 and 5, the rear assembly 100 includes a body assembly, shown as body 110, coupled to and supported by the frame 12; a fluid driver, shown as pump system 200, coupled to and supported by the frame 12; a ladder support member, shown as torque box 300, coupled to and supported by the frame 12; a fluid reservoir, shown as water tank 400, coupled to the body 110 and supported by the torque box 300 and/or the frame 12; and an aerial assembly, shown as aerial assembly 500, pivotally coupled to the torque box 300 and supported by the torque box 300 and/or the frame 12. In some embodiments, the rear assembly 100 does not include the water tank 400. In some embodiments, the rear assembly 100 additionally or alternatively includes an agent or foam tank (e.g., that receives and stores a fire suppressing agent, foam, etc.).

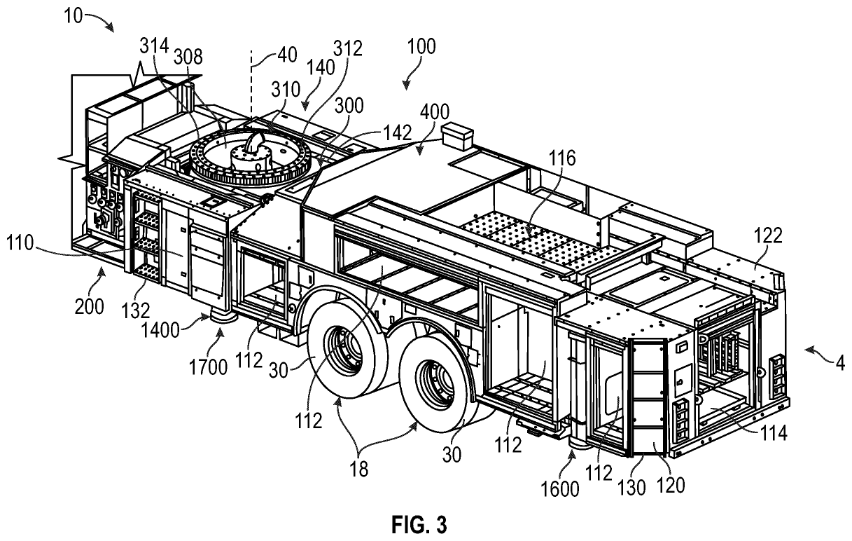

As shown in FIGS. 1-3 and 5, the sides of the body 110 define a plurality of compartments, shown as storage compartments 112. The storage compartments 112 may receive and store miscellaneous items and gear used by emergency response personnel (e.g., helmets, axes, oxygen tanks, hoses, medical kits, etc.). As shown in FIG. 3, the rear end 4 of the body 110 defines a longitudinal storage compartment, shown as ground ladder compartment 114, that extends along the longitudinal axis 14. The ground ladder compartment 114 may receive and store one or more ground ladders. As shown in FIG. 3, a top surface, shown as top platform 122, of the body 110 defines a cavity, shown as hose storage platform 116.

According to the exemplary embodiment shown in FIGS. 1-3, the rear end 4 of the body 110 has notched or clipped corners, shown as chamfered corners 120. According to an exemplary embodiment, the chamfered corners 120 provide for increased turning clearance relative to fire apparatuses that have non-notched or non-clipped (e.g., square, etc.) corners. According to the exemplary embodiment shown in FIG. 5, the rear end 4 of the body 110 does not have notched or clipped corners (e.g., the rear end 4 of the body 110 may have square corners, etc.). As shown in FIGS. 1-3 and 5, the rear assembly 100 includes at least one first selectively deployable ladder, shown as rear ladder 130. According to the exemplary embodiment shown in FIGS. 1-3, a respective rear ladder 130 is coupled to each of the chamfered corners 120 of the body 110. According to the exemplary embodiment shown in FIG. 5, the rear ladder 130 is coupled to a side of body 110 (e.g., at the rear corner thereof). According to an exemplary embodiment, the rear ladder 130 is hingedly coupled to the body 110 and repositionable between a stowed position (e.g., hung up, stored, secured, etc.) and a deployed position (e.g., removed, etc.). The rear ladder 130 may be selectively deployed such that a user may climb the rear ladder 130 to access the top platform 122 of the body 110 and/or one or more components of the aerial assembly 500 (e.g., a work basket, an implement, an aerial ladder assembly, the hose storage platform 116, etc.). In other embodiments, the body 110 has stairs in addition to or in place of the rear ladder 130.

As shown in FIGS. 1 and 3, the rear assembly 100 includes at least one second selectively deployable ladder, shown as side ladder 132, coupled to a side (e.g., a left side, a right side, a driver's side, a passenger's side, etc.) of the body 110. In some embodiments, the rear assembly 100 includes two of the side ladders 132, one coupled to each side of the body 110. According to an exemplary embodiment, the side ladder 132 is hingedly coupled to the body 110 and repositionable between a stowed position and a deployed position. The side ladder 132 may be selectively deployed such that a user may climb the side ladder 132 to access one or more components of the aerial assembly 500 (e.g., a work platform, an aerial ladder assembly, a control console, etc.).

As shown in FIGS. 1 and 3, the body 110 defines a recessed portion, shown as aerial assembly recess 140, positioned (i) rearward of the front cabin 20 and (ii) forward of the water tank 400 and/or the rear axles 18. The aerial assembly recess 140 defines an aperture, shown as pedestal opening 142, rearward of the pump system 200.

According to an exemplary embodiment, the water tank 400 is coupled to the frame 12 with a superstructure (e.g., disposed along a top surface of the torque box 300, etc.). As shown in FIGS. 1 and 3, the water tank 400 is positioned below the aerial ladder assembly 700 and forward of the hose storage platform 116. The water tank 400 is positioned such that the water tank 400 defines a rearward wall of the aerial assembly recess 140. In one embodiment, the water tank 400 stores up to 300 gallons of water. In another embodiment, the water tank 400 stores more than or less than 300 gallons of water (e.g., 100, 200, 250, 350, 400, 500, etc. gallons). In other embodiments, fire apparatus 10 additionally or alternatively includes a second reservoir that stores another firefighting agent (e.g., foam, etc.). In still other embodiments, the fire apparatus 10 does not include the water tank 400 (e.g., in a non-quint configuration, etc.).

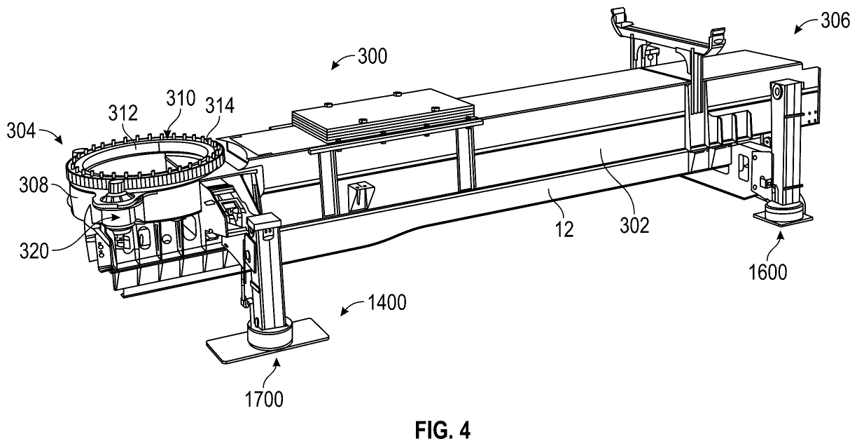

As shown in FIGS. 4 and 6-11, the torque box 300 is releasably coupled (e.g., pinned, etc.) to the frame 12. In one embodiment, the torque box 300 extends laterally the full width between the lateral outsides of the frame rails of the frame 12. As shown in FIGS. 4 and 6-11, the torque box 300 includes a body portion, shown as torque box body 302, having a first end, shown as pedestal end 304, and an opposing second end, shown as non-pedestal end 306. As shown in FIGS. 3, 4, 6-8, and 10, the torque box 300 includes a support, shown as pedestal 308, coupled (e.g., attached, fixed, bolted, welded, etc.) to or proximate the pedestal end 304 of the torque box 300. As shown in FIG. 3, the pedestal 308 extends through the pedestal opening 142 into the aerial assembly recess 140.

As shown in FIGS. 1, 5, and 6, the aerial assembly 500 includes a turntable assembly, shown as turntable 510, pivotally coupled to the pedestal 308 of the torque box 300; a platform, shown work platform 550, coupled to the turntable 510; a console, shown as control console 600, coupled to the turntable 510; a ladder assembly, shown as aerial ladder assembly 700, having a first end (e.g., a base end, a proximal end, a pivot end, etc.), shown as proximal end 702, pivotally coupled to the turntable 510, and an opposing second end (e.g., a free end, a distal end, a platform end, an implement end, etc.), shown as distal end 704; and an implement, shown as work basket 1300, coupled to the distal end 704.

According to an exemplary embodiment shown in FIGS. 1, 5, and 6, the aerial assembly 500 (e.g., the turntable 510, the work platform 550, the control console 600, the aerial ladder assembly 700, the work basket 1300, etc.) is rotatably coupled to the pedestal 308 such that the aerial assembly 500 is selectively repositionable into a plurality of operating orientations about a vertical axis, shown as vertical pivot axis 40. As shown in FIGS. 3 and 4, the torque box 300 includes a pivotable connector, shown as slewing bearing 310, coupled to the pedestal 308. The slewing bearing 310 is a rotational rolling-element bearing with an inner element, shown as bearing element 312, and an outer element, shown as driven gear 314. The bearing element 312 may be coupled to the pedestal 308 with a plurality of fasteners (e.g., bolts, etc.).

As shown in FIGS. 4, a drive actuator, shown as rotation actuator 320, is coupled to the pedestal 308 (e.g., by an intermediate bracket, etc.). The rotation actuator 320 is positioned to drive (e.g., rotate, turn, etc.) the driven gear 314 of the slewing bearing 310. In one embodiment, the rotation actuator 320 is an electric motor (e.g., an alternating current (AC) motor, a direct current motor (DC), etc.) configured to convert electrical energy into mechanical energy. In other embodiments, the rotation actuator 320 is powered by air (e.g., pneumatic, etc.), a fluid (e.g., a hydraulic motor, a hydraulic cylinder, etc.), mechanically (e.g., a flywheel, a power take-off of the engine 60, etc.), or still another power source.

As shown in FIG. 1, the turntable 510 includes a base, shown as rotation base 512. According to an exemplary embodiment, (i) the work platform 550 is coupled to the rotation base 512, (ii) the aerial ladder assembly 700 is pivotally coupled to the rotation base 512, (iii) the control console 600 is coupled to the rotation base 512, and (iv) the rotation base 512 is disposed within the aerial assembly recess 140 and interfaces with and is coupled to the driven gear 314 of slewing bearing 310 such that the aerial assembly 500 is selectively pivotable about the vertical pivot axis 40 using the rotation actuator 320. Accordingly, loading from the work basket 1300, the aerial ladder assembly 700, and/or the work platform 550 may transfer through the turntable 510 into the torque box 300 and the frame 12.

According to an exemplary embodiment, the work platform 550 provides a surface upon which operators (e.g., fire fighters, rescue workers, etc.) may stand while operating the aerial assembly 500 (e.g., with the control console 600, etc.). The control console 600 may be communicably coupled to various components of the fire apparatus 10 (e.g., actuators of the aerial ladder assembly 700, the rotation actuator 320, a water turret, etc.) such that information or signals (e.g., command signals, fluid controls, etc.) may be exchanged from the control console 600. The information or signals may relate to one or more components of the fire apparatus 10. According to an exemplary embodiment, the control console 600 enables an operator (e.g., a fire fighter, etc.) of the fire apparatus 10 to communicate with one or more components of the fire apparatus 10. By way of example, the control console 600 may include at least one of an interactive display, a touchscreen device, one or more buttons (e.g., a stop button configured to cease water flow through a water nozzle, etc.), joysticks, switches, and voice command receivers. An operator may use a joystick associated with the control console 600 to trigger the actuation of the turntable 510 and/or the aerial ladder assembly 700 to a desired angular position (e.g., to the front, back, or side of fire apparatus 10, etc.). By way of another example, an operator may engage a lever associated with the control console 600 to trigger the extension or retraction of the aerial ladder assembly 700.

In some embodiments, the aerial assembly 500 does not include the work basket 1300. In some embodiments, the work basket 1300 is replaced with or additionally includes a nozzle (e.g., a deluge gun, a water cannon, a water turret, etc.) or other tool. By way of example, the nozzle may be connected to a water source (e.g., the water tank 400, an external source, etc.) with a conduit extending along the aerial ladder assembly 700 (e.g., along the side of the aerial ladder assembly 700, beneath the aerial ladder assembly 700, in a channel provided in the aerial ladder assembly 700, etc.). By pivoting the aerial ladder assembly 700 into a raised position, the nozzle may be elevated to expel water from a higher elevation to facilitate suppressing a fire.

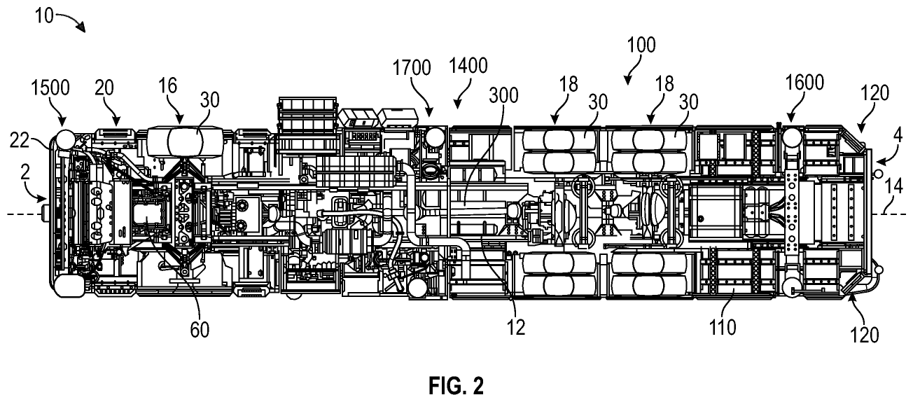

As shown in FIGS. 1-6, the fire apparatus 10 includes a stability system, shown as stability assembly 1400. As shown in FIGS. 1 and 2, the stability assembly 1400 includes first stabilizers, shown as front downriggers 1500, coupled to each lateral side of the front bumper 22 at the front end 2 of the front cabin 20. In other embodiments, the front downriggers 1500 are otherwise coupled to the fire apparatus 10 (e.g., to the front end 2 of the frame 12, etc.). In some embodiments, the stability assembly 1400 does not include the front downriggers 1500. According to an exemplary embodiment, the front downriggers 1500 are selectively deployable (e.g., extendable, etc.) downward to engage a ground surface.

As shown in FIGS. 1-4 and 6, the stability assembly 1400 includes one or more second stabilizers, shown as rear downriggers 1600. According to the exemplary embodiment shown in FIGS. 1-4, the rear downriggers 1600 are coupled to each lateral side of the rear end 4 of the frame 12 and/or the rear end of the torque box 300. According to the exemplary embodiment shown in FIG. 6, the stability assembly 1400 includes a single rear downrigger 1600 coupled to the rear end 4 of the frame 12 and/or the rear end of the torque box 300 (e.g., along the longitudinal axis 14). According to an exemplary embodiment, the rear downriggers 1600 are selectively deployable (e.g., extendable, etc.) downward to engage a ground surface.

As shown in FIGS. 1-6, the stability assembly 1400 includes third stabilizers, shown outriggers 1700, coupled to the front (e.g., the pedestal end 304 in FIG. 4, the non-pedestal end in FIG. 6) of the torque box 300. According to an exemplary embodiment, the outriggers 1700 are selectively deployable (e.g., extendable, etc.) outward from each of the lateral sides of the body 110 and/or downward to engage a ground surface. According to an exemplary embodiment, the outriggers 1700 are extendable up to a distance of eighteen feet (e.g., measured between the center of a pad of a first outrigger and the center of a pad of a second outrigger, etc.). In other embodiments, the outriggers 1700 are extendable up to a distance of less than or greater than eighteen feet.

According to an exemplary embodiment, the front downriggers 1500, the rear downriggers 1600, and the outriggers 1700 are positioned to transfer the loading from the aerial ladder assembly 700 to the ground. For example, a load applied to the aerial ladder assembly 700 (e.g., a fire fighter at the distal end 704, a wind load, etc.) may be conveyed into to the turntable 510, through the pedestal 308 and the torque box 300, to the frame 12, and into the ground through the front downriggers 1500, the rear downriggers 1600, and/or the outriggers 1700. When the front downriggers 1500, the rear downriggers 1600, and/or the outriggers 1700 engage with a ground surface, portions of the fire apparatus 10 (e.g., the front end 2, the rear end 4, etc.) may be elevated relative to the ground surface. One or more of the wheel and tire assemblies 30 may remain in contact with the ground surface, but may not provide any load bearing support. While the fire apparatus 10 is being driven or not in use, the front downriggers 1500, the rear downriggers 1600, and the outriggers 1700 may be retracted into a stored position.

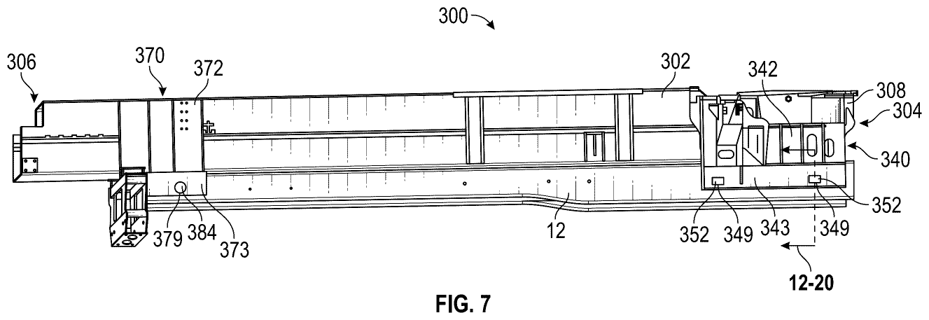

As shown in FIGS. 7-11, the torque box 300 includes (a) a first mounting assembly including a first pair of mounts (e.g., braces, struts, brackets, coupling assemblies, etc.), shown as first mounts 340, positioned along opposing lateral sides of torque box 300 at or proximate the pedestal end 304 of the torque box 300 and (b) a second mounting assembly including a second pair of mounts, shown as second mounts 370, positioned along opposing lateral sides of the torque box 300 at or proximate the non-pedestal end 306 of the torque box 300. In other embodiments, the first mounts 340 are positioned at or proximate the non-pedestal end 306 of the torque box 300 and the second mounts 370 are positioned at or proximate the pedestal end 304 of the torque box 300. According to an exemplary embodiment, the torque box 300, the first mounts 340, and the second mounts 370 are integrally formed (e.g., form a single weldment, welded, etc.). In other embodiments, one or more components the torque box 300 are otherwise coupled together (e.g., fastened, etc.).

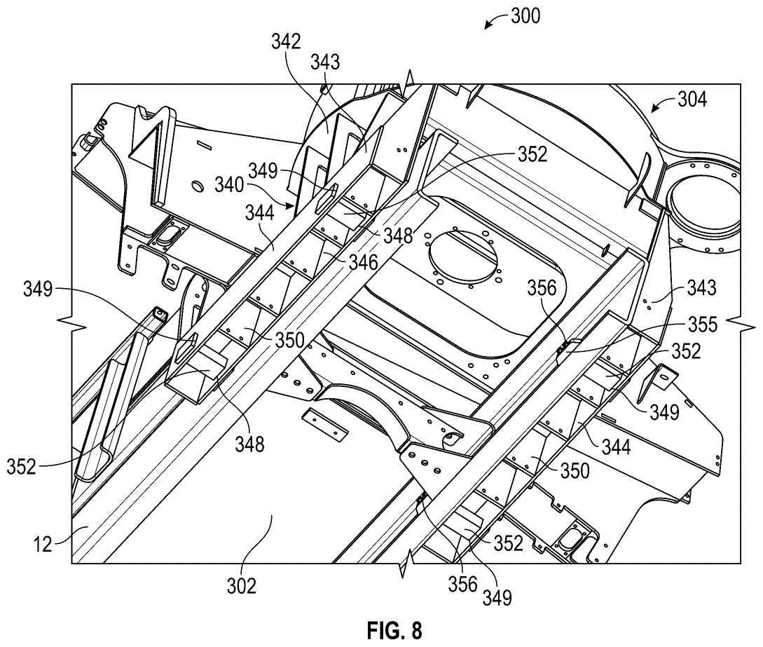

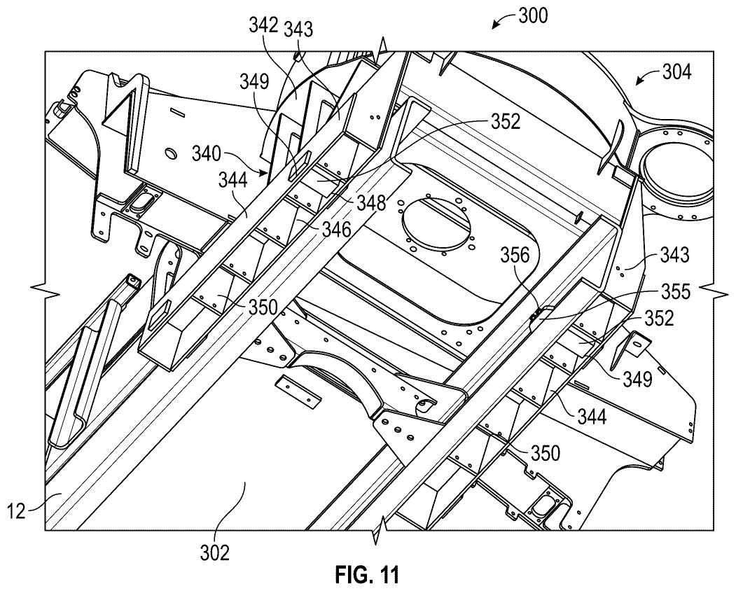

As shown in FIGS. 7, 8, 10, and 11, each of the first mounts 340 includes (a) a first or upper portion, shown as first upper bracket 342, coupled (e.g., welded) to the torque box 300 and (b) a second or lower portion, shown as first lower bracket 343, extending downward from the first upper bracket 342. In some embodiments, each of the first mounts 340 is a single, unitary component or weldment. As shown in FIGS. 8 and 11, each of the first lower brackets 343 has an outer plate, shown as first outer plate 344, an inner plate, shown as first inner plate 346, and a plurality of ribs (e.g., rafter, girder, braces, etc.), shown as first ribs 350, extending between the first outer plate 344 and the first inner plate 346. The first outer plates 344 and the first inner plates 346 extend parallel to the longitudinal frame rails of the frame 12 when the torque box 300 is coupled to the frame 12. Each of the first ribs 350 is coupled to an outer face of one of the first inner plates 346 and is coupled to an inner face of one of the first outer plates 344. The first ribs 350 are spaced along the first inner plates 346 and the first outer plates 344. In another embodiment, each of the first lower brackets 343 is configured as a single plate and/or does not include ribs.

According to the exemplary embodiment shown in FIGS. 7, 8, 10-15, 21, 22, and 24, the first outer plates 344 and the first inner plates 346 of the first lower brackets 343 are configured to be positioned outside of the frame rails of the frame 12 when the torque box 300 is in a position to be releasably coupled to the frame 12. For example, each of the first inner plates 346 may be positioned between one of the first outer plates 344 and one of the frame rails of the frame 12 when the torque box 300 is in a position to be releasably coupled to the frame 12. In some embodiments, the inside surface of each of the first inner plates 346 is configured to interface with (e.g., contact, etc.) the outside surface of one of the frame rails of the frame 12 when the torque box 300 is in a position to be releasably coupled to the frame 12. In other embodiments, the inside surface of each of the first inner plates 346 is configured to be spaced apart from (e.g., have a gap between, not contact, etc.) the outside surfaces of the frame rails of the frame 12 when the torque box 300 is in a position to be releasably coupled to the frame 12.

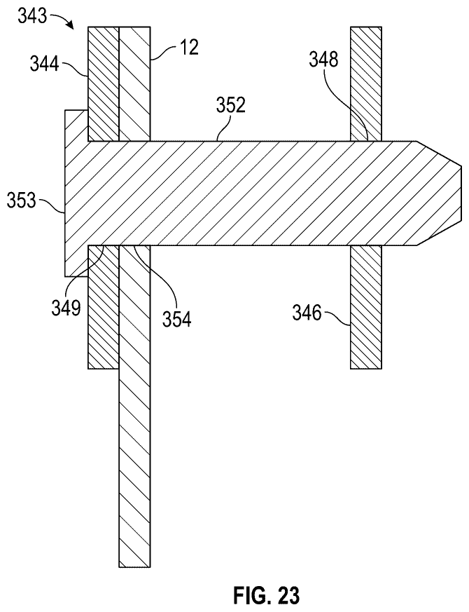

According to the exemplary embodiment shown in FIG. 23, the first outer plates 344 and the first inner plates 346 of the first lower brackets 343 are configured to be positioned on opposite sides of one of the frame rails of the frame 12 when the torque box 300 is in a position to be releasably coupled to the frame 12. For example, each of the frame rails of the frame 12 may be positioned between one of the first outer plates 344 and one of the first inner plates 346 when the torque box 300 is in a position to be releasably coupled to the frame 12. In other embodiments, the first outer plates 344 and the first inner plates 346 of the first lower brackets 343 are configured to be positioned between the frame rails of the frame 12 when the torque box 300 is in a position to be releasably coupled to the frame 12. In some embodiments, the inside surface of each of first outer plates 344 is configured to interface with (e.g., contact, etc.) the outside surface of one of the frame rails of the frame 12 when the torque box 300 is in a position to be releasably coupled to the frame 12. In other embodiments, the inside surface of each of first outer plates 344 is configured to be spaced apart from (e.g., have a gap between, not contact, etc.) the outside surfaces of the frame rails of the frame 12 when the torque box 300 is in a position to be releasably coupled to the frame 12.

In some embodiments, as shown in FIGS. 7 and 8, (a) each of the first lower brackets 343 defines a first plurality (e.g., two or more) of apertures (e.g., holes, slots, etc.), shown as first mounting apertures 348, positioned at least partially and spaced along the length of each of the first inner plates 346 and (b) each of the first outer plates 344 defines a second plurality (e.g., two or more) of apertures, shown as second mounting apertures 349, positioned at least partially and spaced along the length of each of the first outer plates 344 and configured to align with one of the first mounting apertures 348. According to an exemplary embodiment, each of the first mounting apertures 348 and the second mounting apertures 349 has a non-circular shape (e.g., rectangular, square, etc.). In other embodiments, the each of the first mounting apertures 348 and the second mounting apertures 349 has a circular shape.

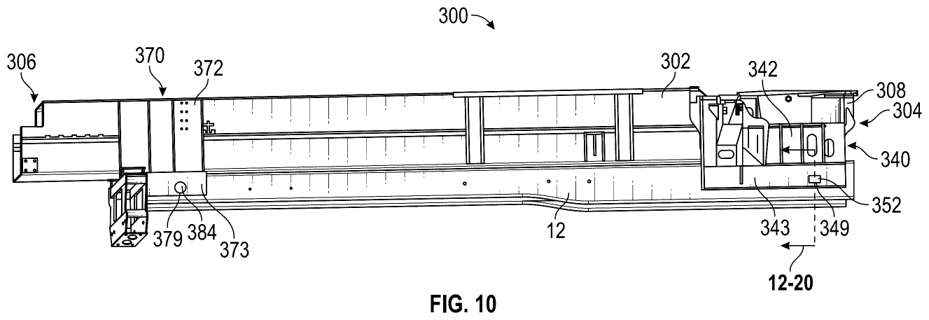

In some embodiments, as shown in FIGS. 10 and 11, (a) each of the first lower brackets 343 defines a single one of the first mounting aperture 348 positioned along the length of each of the first inner plates 346 and (b) each of the first outer plates 344 define a single one of the second mounting aperture 349 positioned along the length of each of the first outer plates 344 and configured to align with one of the first mounting apertures 348. According to the exemplary embodiment shown in FIGS. 10 and 11, the single one of the first mounting apertures 348 and the single one of the second mounting apertures 349 are positioned proximate the pedestal end 304 of the torque box 300. In other embodiments, the single one of the first mounting apertures 348 and the single one of the second mounting apertures 349 are otherwise positioned (e.g., at the front of the first lower brackets 343, at the middle of the first lower brackets 343, etc.).

According to the exemplary embodiment shown in FIGS. 7, 8, 10, and 11, the first mounting apertures 348 and the second mounting apertures 349 have a rectangular shape. In other embodiments, each of the first mounting apertures 348 and the second mounting apertures 349 have another non-circular shape (e.g., square, oval, octagon, hexagon, etc.). In still other embodiments, the first mounting apertures 348 and the second mounting apertures 349 have a circular shape. In yet other embodiments, at least one of the first mounting apertures 348 and the second mounting apertures 349 has a first shape (e.g., rectangular), and at least one of the first mounting apertures 348 and the second mounting apertures 349 has a second, different shape (e.g., circular).

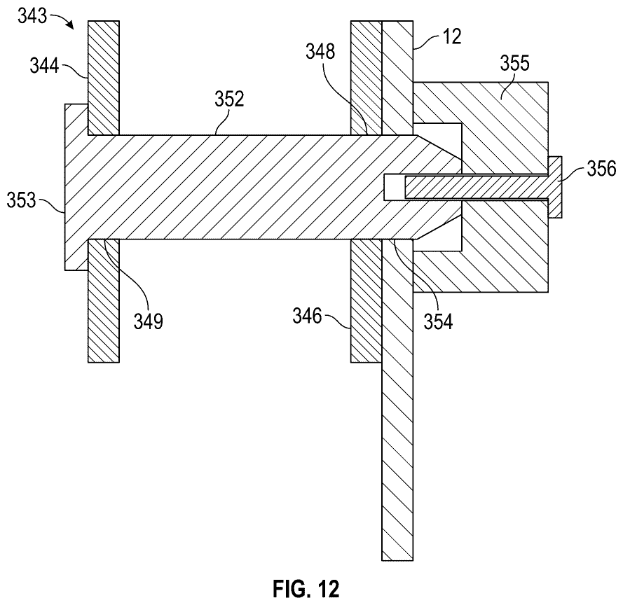

As shown in FIGS. 12-15 and 21-24, the frame 12 defines a first plurality of apertures, shown as first receiving apertures 354, positioned at least partially and spaced along a length of the webbing of the longitudinal frame rails of the frame 12 and configured to align with one set of the first mounting apertures 348 and the second mounting apertures 349 when the torque box 300 is in a position to be releasably coupled to the frame 12. According to an exemplary embodiment, each of the first receiving apertures 354 is configured to have a shape that is the same or similar to the first mounting apertures 348 and the second mounting apertures 349.

As shown in FIGS. 7, 8, 10-15, and 21-24, the first mounting apertures 348, the second mounting apertures 349, and the first receiving apertures 354 align to selectively receive a first plurality of couplers (e.g., pins, shafts, mandrels, connectors, non-bolt couplers or connectors, non-threaded couplers or connectors, threaded couplers or connectors, etc.), shown as first mounting pins 352, to releasably couple the first lower brackets 343 to the longitudinal frame rails of the frame 12 and, thereby, the torque box 300 to the frame 12. According to an exemplary embodiment, the first mounting pins 352 have a cross-sectional shape that corresponds with the shape of the first mounting apertures 348, the second mounting apertures 349, and the first receiving apertures 354. According to the exemplary embodiment shown in FIGS. 7, 8, 10, and 11, each of the first mounting pins 352 has a rectangular cross-sectional shape. Such rectangular pins may have (a) a width between about two inches and about five inches (e.g., at least 2.0 inches, at least 2.5 inches, at least 3.0 inches, at least 3.5 inches, at least 4.0 inches, at least 4.5 inches, at least 5.0 inches, etc.) and (b) a width between about one inch and about three inches (e.g., 1.0 inch, 1.5 inches, 2.0 inches, 2.5 inches, 3.0 inches, etc.). In other embodiments, each of the first mounting pins 352 has another cross-sectional shape (e.g., square, hexagon, octagon, oval, circle, etc.). In yet other embodiments, at least one of the first mounting pins 352 has a first cross-sectional shape (e.g., rectangular), and at least one of the first mounting pins 352 has a second, different cross-sectional shape (e.g., circular). According to the exemplary embodiment shown in FIGS. 7 and 8, the torque box 300 is coupled to the frame 12 using a total of four of the first mounting pins 352 (i.e., two on each side). According to the exemplary embodiment shown in FIGS. 10 and 11, the torque box 300 is coupled to the frame 12 using a total of two of the first mounting pins 352 (i.e., one on each side). In other embodiments, the torque box 300 is coupled to the frame using a different number of the first mounting pins 352 (e.g., six, eight, etc.).

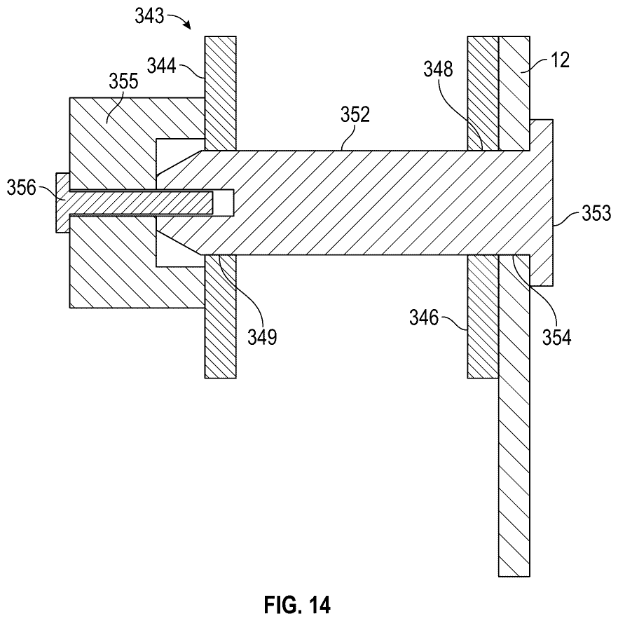

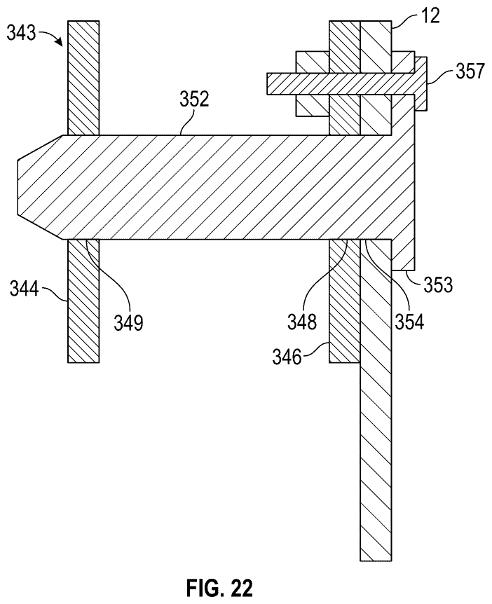

According to the exemplary embodiment shown in FIGS. 12-15 and 21-24, each of the first mounting pins 352 includes a flared end (e.g., splayed, a flange, a first flared end, etc.), shown as flared end 353. As shown in FIGS. 12, 13, 15, 21, and 23, the flared ends 353 have a larger cross-section than the second mounting apertures 349 and are configured to engage with the outer surface of the first outer plates 344 to prevent the first mounting pins 352 from fully passing through (e.g., drifting through, fitting within, etc.) the first outer plates 344 when the first mounting pins 352 are inserted into the first mounting apertures 348, the second mounting apertures 349, and the first receiving apertures 354 to couple the torque box 300 to the frame 12. As shown in FIGS. 14 and 22, the flared ends 353 have a larger cross-section than the first receiving apertures 354 of the frame 12 and are configured to engage with the inner surface of the frame rails of the frame 12 to prevent the first mounting pins 352 from fully passing through the frame rails of the frame 12 when the first mounting pins 352 are inserted into the first mounting apertures 348, the second mounting apertures 349, and the first receiving apertures 354 to couple the torque box 300 to the frame 12. In other embodiments, the flared ends 353 have a larger cross-section than the first mounting apertures 348 of the first inner plates 346 and are configured to engage with the inner surface of the first inner plate 346 to prevent the first mounting pins 352 from fully passing through the first mounting apertures 348 when the first mounting pins 352 are inserted into the first mounting apertures 348, the second mounting apertures 349, and the first receiving apertures 354 to couple the torque box 300 to the frame 12 (e.g., when the frame rails of the frame 12 are positioned between the first outer plates 344 and the first inner plates 346, etc.).

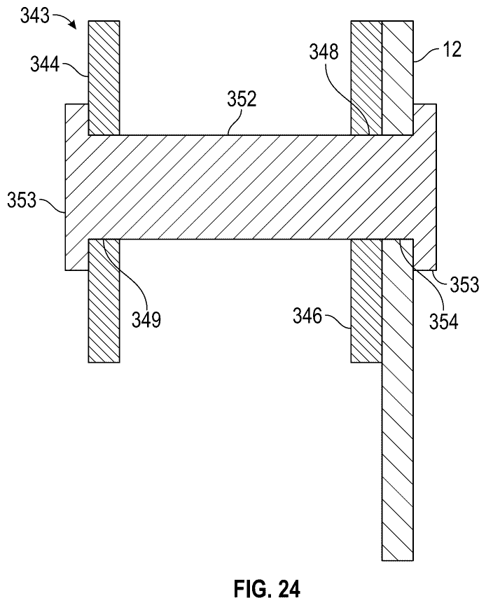

As shown in FIG. 24, each of the first mounting pins 352 includes a first flared end 353 on a first end of the first mounting pins 352 and a second flared end 353 on a second opposing end of the first mounting pins 352. The first flared ends 353 have a larger cross-section than the second mounting apertures 349 and are configured to engage with the outer surface of the first outer plates 344 to prevent the first mounting pins 352 from fully passing through the first outer plates 344 when the first mounting pins 352 are inserted into the first mounting apertures 348, the second mounting apertures 349, and the first receiving apertures 354 to couple the torque box 300 to the frame 12. The second flared ends 353 have a larger cross-section than the first receiving apertures 354 of the frame 12 and are configured to engage with the inner surface of the frame rails of the frame 12 to prevent the first mounting pins 352 from fully passing through the frame rails of the frame 12 when the first mounting pins 352 are inserted into the first mounting apertures 348, the second mounting apertures 349, and the first receiving apertures 354 to couple the torque box 300 to the frame 12. For example, the first mounting pins 352 may only include the first of the flared ends 353 when the first mounting pins 352 are inserted into the first mounting apertures 348, the second mounting apertures 349, and the first receiving apertures 354 to couple the torque box 300 to the frame 12 and the second of the flared ends 353 may be coupled (e.g., attached, fixed, bolted, welded, etc.) to the first of the first mounting pins 352 after the first mounting pins 352 are inserted into the first mounting apertures 348, the second mounting apertures 349, and the first receiving apertures 354. In some embodiments, the first mounting pins 352 do not include the flared ends 353.

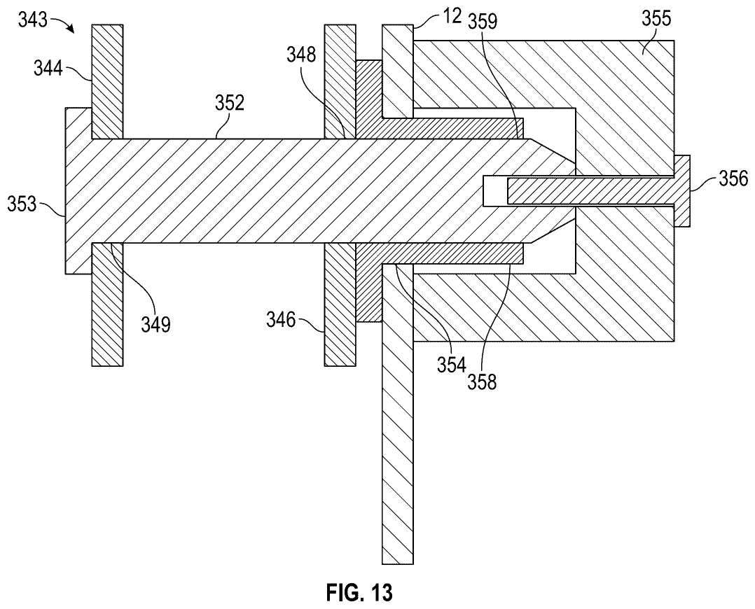

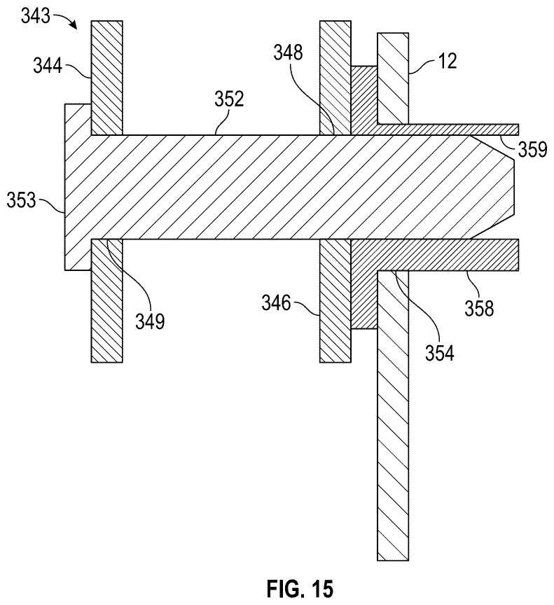

In some embodiments, shown in FIGS. 13 and 15, a bushing (e.g., sheath, liner, etc.), shown as adjustment bushing 358, is positioned between at least one of the first mounting pins 352 and at least one of the first receiving apertures 354 when the first mounting pins 352 couple the torque box 300 to the frame 12. In some embodiments, a respective adjustment bushing 358 is positioned between each set of the first mounting pins 352 and the first receiving apertures 354. The adjustment bushings 358 are configured to accommodate some misalignment between each of the first mounting apertures 348 and the first receiving apertures 354 when the torque box 300 is in a position to be releasably coupled to the frame 12. In some embodiments, the adjustment bushings 358 are additionally or alternatively positioned (a) between each of the first mounting pins 352 and the first mounting apertures 348 and/or (b) between each of the first mounting pins 352 and the second mounting apertures 349. According to the exemplary embodiment shown in FIG. 13, each of the adjustment bushings 358 defines an aperture, shown as first bushing apertures 359, centered on the axis of the adjustment bushings 358. According to the exemplary embodiment shown in FIG. 15, each of the adjustment bushings 358 defines the first bushing apertures 359, offset from the axis of each of the adjustment bushings 358 in order to accommodate some misalignment between (i) the first mounting apertures 348 and the second mounting apertures 349 and (ii) the first receiving apertures 354 when the torque box 300 is in a position to be releasably coupled to the frame 12. As a result, (i) the first mounting apertures 348 and the second mounting apertures 349 and (ii) the first receiving apertures 354 may be misaligned due to manufacturing tolerances and still receive the first mounting pins 352 to couple the torque box 300 and the frame 12.

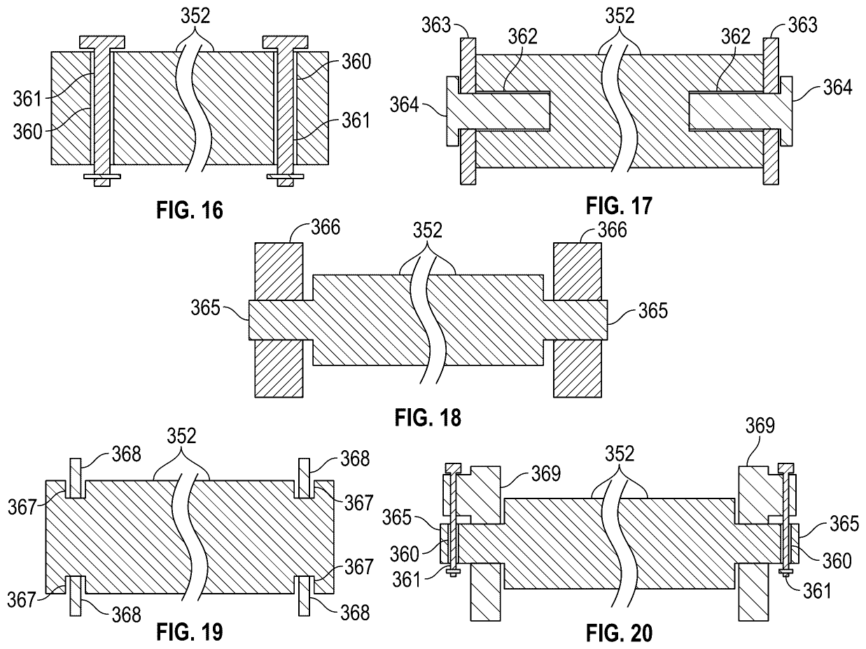

According to an exemplary embodiment shown in FIGS. 8 and 11-14, a plurality of retaining members (e.g., brackets, keepers, pins, nuts, etc.), shown as first retainers 355, are positioned to interface with a free end (e.g., an end opposing the flange 353, etc.) of each of the first mounting pins 352. When the first mounting pins 352 are coupling the torque box 300 and the frame 12, each of the first retainers 355 releasably engages the free end of one of the first mounting pins 352 and is secured thereto using one or more fasteners (e.g., bolts, screws, pins, etc.), shown as first retainer fasteners 356. The first retainers 355 are configured to engage with the inner surface of the frame rails of the frame 12, as shown in FIGS. 8 and 10-13, or the outer surface of the first outer plates 344, as shown in FIG. 14, to prevent the incidental removal of the first mounting pins 352 from the first mounting apertures 348, the second mounting apertures 349, and the first receiving apertures 354. In other embodiments (see, e.g., FIGS. 16-22), one or more of the first mounting pins 352 is held in position using a different form of fastener or retainer (e.g., clevis pins, cotter pins, linch pins, nuts, pairs of nuts and bolts etc.) and/or other means (e.g., friction, press fit, etc.). As shown in FIG. 16, one or more of the first mounting pins 352 defines a pair of apertures, shown as pin apertures 360. The pin apertures 360 are positioned at opposing ends of the first mounting pins 352 and extend through the first mounting pins 352. A plurality of retainers (e.g., clevis pins, dowl pins, cotter pins, linch pins, clamp pins, hairpin, spring pin, taper pin, etc.), shown as retaining pins 361, are configured to extend through the pin apertures 360 and couple to the first mounting pins 352 when the first mounting pins 352 are coupling the torque box 300 and the frame 12. When the first mounting pins 352 are coupling the torque box 300 and the frame 12 and the retaining pins 361 are coupled to the first mounting pins 352, the retaining pins 361 are configured to engage with the inner surface of the frame rails of the frame 12 or engage with the outer surface of the first outer plate 344 (e.g., such that the inner surface of the frame rails of the frame 12 and the outer surface of the first outer plate 344 are between a pair of the retaining pins 361, etc.) to prevent the incidental removal of the first mounting pins 352 from the first mounting apertures 348, the second mounting apertures 349, and the first receiving apertures 354.

In other embodiments, one or more of the first mounting pins 352 include the flared end 353 at a first end of thereof and define one of the pin apertures 360 configured to receive one of the retaining pins 361 positioned proximate a second end thereof opposite the first end. For example, in some embodiments, when the first mounting pins 352 are coupling the torque box 300 and the frame 12 and the retaining pins 361 are coupled to the first mounting pins 352, the flared ends 353 are configured to engage with the outer surface of the first outer plates 344 to prevent the first mounting pins 352 from fully passing through the first outer plates 344 and the retaining pins 361 are configured to engage with the inner surface of the frame rails of the frame 12 to prevent the first mounting pins 352 from fully passing through the frame rails of the frame 12 when the first mounting pins 352 are inserted into the first mounting apertures 348, the second mounting apertures 349, and the first receiving apertures 354 to couple the torque box 300 to the frame 12. As another example, in some embodiments, when the first mounting pins 352 are coupling the torque box 300 and the frame 12 and the retaining pins 361 are coupled to the first mounting pins 352, the flared end 353 are configured to engage with the inner surface of the frame rails of the frame 12 to prevent the first mounting pins 352 from fully passing through the frame rails of the frame 12 and the retaining pins 361 are configured to engage with the outer surface of the first outer plates 344 to prevent the first mounting pins 352 from fully passing through the first outer plates 344 when the first mounting pins 352 are inserted into the first mounting apertures 348, the second mounting apertures 349, and the first receiving apertures 354 to couple the torque box 300 to the frame 12.

As shown in FIG. 17, one or more of the first mounting pins 352 define a pair of openings, shown as retaining openings 362. The retaining openings 362 are positioned at opposing ends of the first mounting pins 352. A plurality of retainers (e.g., plates, bushings, etc.), shown as retaining washers 363, are configured to be coupled to the opposing ends of the first mounting pins 352 using a plurality of fasteners, shown as retaining fasteners 364, that extend through the retaining washers 363 and engage with the retaining openings 362. In some embodiments, the retaining openings 362 define threads configured to engage the retaining fasteners 364. In other embodiments, the retaining openings 362 are configured to engage the retaining fasteners 364 through other means (e.g., friction, press fit, etc.). The retaining washers 363 are configured to engage with the outer surface of the first outer plates 344 to prevent the first mounting pins 352 from fully passing through the first outer plates 344 and are configured to engage with the inner surface of the frame rails of the frame 12 to prevent the first mounting pins 352 from fully passing through the frame rails of the frame 12 when the first mounting pins 352 are inserted into the first mounting apertures 348, the second mounting apertures 349, and the first receiving apertures 354 to couple the torque box 300 to the frame 12. According to an exemplary embodiment, the retaining washers 363 have a larger cross-section and/or a larger maximum width, length, or diameter than the second mounting apertures 349 and the first receiving apertures 354.

In other embodiments, one or more of the first mounting pins 352 include the flared end 353 on a first end thereof and define a single one of the retaining openings 362 configured to receive one of the retaining fasteners 364 on a second end thereof opposite the first end. In still other embodiments, the retaining fasteners 364 are configured to prevent the first mounting pins 352 from fully passing through the first outer plates 344 and/or the frame rails of the frame 12 without the retaining washers 363. For example, the retaining fasteners 364 may be configured to engage with the outer surface of the first outer plates 344 to prevent the first mounting pins 352 from fully passing through the first outer plates 344 and may be configured to engage with the inner surface of the frame rails of the frame 12 to prevent the first mounting pins 352 from fully passing through the frame rails of the frame 12 when the first mounting pins 352 are inserted into the first mounting apertures 348, the second mounting apertures 349, and the first receiving apertures 354 to couple the torque box 300 to the frame 12. In some embodiments, the head of the retaining fasteners 364 have a larger cross-section and/or a larger maximum width than the second mounting aperture 349 and/or the first receiving apertures 354 of the frame 12.

As shown in FIG. 18, one or more of the first mounting pins 352 include a pair of posts (e.g., shafts, etc.), shown as extension posts 365, extending from opposing ends of the first mounting pins 352. A plurality of retainers, shown as retaining nuts 366, are configured to couple to the extension posts 365. In some embodiments, the extension posts 365 define threads configured to engage with the retaining nuts 366. In other embodiments, the extension posts 365 are configured to engage the retaining nuts 366 through other means (e.g., friction, press fit, etc.). The retaining nuts 366 are configured to engage with the outer surface of the first outer plates 344 to prevent the first mounting pins 352 from fully passing through the first outer plates 344 and are configured to engage with the inner surface of the frame rails of the frame 12 to prevent the first mounting pins 352 from fully passing through the frame rails of the frame 12 when the first mounting pins 352 are inserted into the first mounting apertures 348, the second mounting apertures 349, and the first receiving apertures 354 to couple the torque box 300 to the frame 12. In some embodiments, the retaining nuts 366 have a larger cross-section and/or a larger maximum width than the second mounting apertures 349 and the first receiving apertures 354 of the frame 12. In other embodiments, the retaining nuts 366 are smaller than the second mounting apertures 349 and the first receiving apertures 354 and, instead, the retaining washers 363 are positioned between the extension posts 365 and the retaining nuts 366.

In other embodiments, one or more of the first mounting pins 352 include the flared end 353 at a first end thereof and define a single one of the extension posts 365 configured to receive one of the retaining nuts 366 at a second end thereof opposite the first end. In various embodiments, the retaining nuts 366 are configured to engage with the outer surface of the first outer plates 344 and/or with the inner surface of the frame rails of the frame 12 without providing a clamping force to the outer surface of the first outer plates 344 and/or the inner surface of the frame rails of the frame 12. For example, the retaining nuts 366 may be configured such that a clamping force is not transferred between the extension posts 365 and the outer surface of the first outer plates 344 and/or the inner surface of the frame rails of the frame 12 when the retaining nuts 366 are coupled to the first mounting pins 352.

As shown in FIG. 19, one or more of the first mounting pins 352 define a pair of interfaces (e.g., grooves, notches, etc.), shown as retaining grooves 367, positioned proximate opposing ends of the first mounting pins 352. A plurality of retainers (e.g., clips, e-rings, O-rings, c-clips, snap rings, etc.), shown as retaining rings 368, are configured to engage the retaining grooves 367. The retaining rings 368 are configured to engage with the outer surface of the first outer plates 344 to prevent the first mounting pins 352 from fully passing through the first outer plates 344 and are configured to engage with the inner surface of the frame rails of the frame 12 to prevent the first mounting pins 352 from fully passing through the frame rails of the frame 12 when the first mounting pins 352 are inserted into the first mounting apertures 348, the second mounting apertures 349, and the first receiving apertures 354 to couple the torque box 300 to the frame 12. According to an exemplary embodiment, the retaining rings 368 have a larger cross-section and/or a larger maximum width than the second mounting apertures and the first receiving apertures 354 of the frame 12. In other embodiments, one or more of the first mounting pins 352 include the flared end 353 at a first end thereof and define a single one of the retaining grooves 367 configured to engage one of the retaining rings 368 proximate a second end thereof opposite the first end.

As shown in FIG. 20, one or more of the first mounting pins 352 include the extension posts 365. A plurality of anti-rotation retainers, shown as castle nuts 369, are configured to couple to the extension posts 365. The extension posts 365 define threads configured to engage the castle nuts 369. The castle nuts 369 are configured to engage with the outer surface of the first outer plates 344 to prevent the first mounting pins 352 from fully passing through the first outer plates 344 and are configured to engage with the inner surface of the frame rails of the frame 12 to prevent the first mounting pins 352 from fully passing through the frame rails of the frame 12 when the first mounting pins 352 are inserted into the first mounting apertures 348, the second mounting apertures 349, and the first receiving apertures 354 to couple the torque box 300 to the frame 12. In some embodiments, the castle nuts 369 have a larger cross-section and/or a larger maximum width than the second mounting apertures 349 and the first receiving apertures 354 of the frame 12. In other embodiments, the castle nuts 369 are smaller than the second mounting apertures 349 and the first receiving apertures 354 and, instead, the retaining washers 363 are positioned between the extension posts 365 and the castle nuts 369. As shown in FIG. 20, the extension posts 365 define the pin apertures 360 extending therethrough. The pin apertures 360 are configured to receive the retaining pins 361 when the castle nuts 369 are engaged with the extension posts 365. The castle nuts 369 define teeth configured to engage a respective one of the retaining pins 361 when the retaining pins 361 are coupled to the first mounting pins 352. The engagement between the castle nuts 369 and the retaining pins 361 prevents rotation of the castle nuts 369 such that the castle nuts 369 cannot be unthreaded from the extension posts 365 when the castle nuts 369 are engaged with the retaining pins 361.

In other embodiments, one or more of the first mounting pins 352 include the flared end 353 at a first end thereof and define a single one of the extension posts 365 configured to receive one of the castle nuts 369 and one of the retaining pins 361 proximate a second end thereof opposite the first end. In various embodiments, the castle nuts 369 are configured to engage with the outer surface of the first outer plates 344 and/or with the inner surface of the frame rails of the frame 12 without providing a clamping force on the outer surface of the first outer plates 344 and/or on the inner surface of the frame rails of the frame 12. For example, the castle nuts 369 may be configured such that a clamping force is not transferred between the extension posts 365 and the outer surface of the first outer plates 344 and/or the inner surface of the frame rails of the frame 12 when the castle nuts 369 are coupled to the first mounting pins 352.

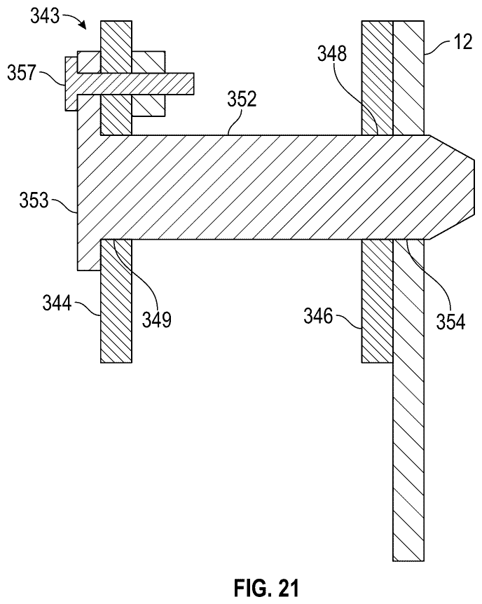

As shown in FIGS. 21 and 22, a plurality of fasteners (e.g., bolts, screws, pins, pairs of nuts and bolts, etc.), shown as flare fasteners 357, are configured to interface with the flared end 353 of the first mounting pins 352. When the first mounting pins 352 are coupling the torque box 300 and the frame 12, each of the flare fasteners 357 is configured to secure the flared end 353 of one of the first mounting pins 352 to the frame 12 or the first lower bracket 343. As shown in FIG. 21, the flare fasteners 357 are configured to engage with the first outer plate 344 of the first lower bracket 343 and the flared end 353 to prevent the incidental removal of the first mounting pins 352 from the first mounting apertures 348, the second mounting apertures 349, and the first receiving apertures 354. As shown in FIG. 22, the flare fasteners 357 are configured to engage with the frame rails of the frame 12, the first inner plate 346, and the flared end 353 to prevent the incidental removal of the first mounting pins 352 from the first mounting apertures 348, the second mounting apertures 349, and the first receiving apertures 354. In other embodiments, the flare fasteners 357 are configured to engage with the inner surface of the first inner plate 346 of the first lower bracket 343 and the flared end 353 to prevent the incidental removal of the first mounting pins 352 from the first mounting apertures 348, the second mounting apertures 349, and the first receiving apertures 354 (e.g., when the frame rails of the frame 12 are positioned between the first outer plates 344 and the first inner plates 346, etc.).

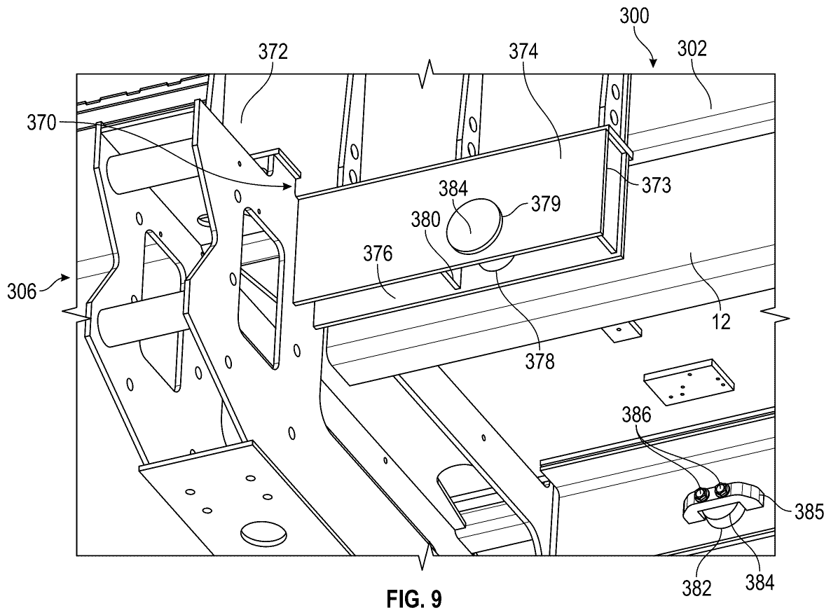

As shown in FIGS. 7, 9, and 10 each of the second mounts 370 includes (a) a first or upper portion, shown as second upper bracket 372, coupled (e.g., welded) to the torque box 300 and (b) a second or lower portion, shown as second lower bracket 373. In some embodiments, each of the second mounts 370 is a single, unitary component or weldment. As shown in FIG. 9, each of the second lower brackets 373 has an outer plate, shown as second outer plate 374, an inner plate, shown as second inner plate 376, and a plurality of ribs (e.g., rafter, girder, braces, etc.), shown as second ribs 380, extending between the second outer plate 374 and the second inner plate 376. The second outer plates 374 and the second inner plates 376 extend parallel to the longitudinal frame rails of the frame 12 when the torque box 300 is coupled to the frame 12. Each of the second ribs 380 is coupled to an outer face of one of the second inner plates 376 and is coupled to an inner face of one of the second outer plates 374. The second ribs 380 are spaced along the second inner plates 376 and the second outer plates 374. In another embodiment, each of the second lower brackets 373 is configured as a single plate and/or do not include ribs.

According to the exemplary embodiment shown in FIGS. 7, 9, and 10, the second outer plates 374 and the second inner plates 376 of the second lower brackets 373 are configured to be positioned outside of the frame rails of the frame 12 when the torque box 300 is in a position to be releasably coupled to the frame 12. For example, each of the second inner plates 376 may be positioned between one of the second outer plates 374 and one of the frame rails of the frame 12 when the torque box 300 is in a position to be releasably coupled to the frame 12. In some embodiments, the inside surface of each of the second inner plates 376 is configured to interface with (e.g., contact, etc.) the outside surface of one of the frame rails of the frame 12 when the torque box 300 is in a position to be releasably coupled to the frame 12. In other embodiments, the inside surface of each of the second inner plates 376 is configured to be spaced apart from (e.g., have a gap between, not contact, etc.) the outside surfaces of the frame rails of the frame 12 when the torque box 300 is in a position to be releasably coupled to the frame 12.

In other embodiments, the second outer plates 374 and the second inner plates 376 of the second lower brackets 373 are configured to be on opposite sides of one of the frame rails of the frame 12 when the torque box 300 is in a position to be releasably coupled to the frame 12. For example, each of the frame rails of the frame 12 may be positioned between one of the second outer plates 374 and one of the second inner plates 376 when the torque box 300 is in a position to be releasably coupled to the frame 12. In other embodiments, the second outer plates 374 and the second inner plates 376 of the second lower brackets 373 are configured to be positioned between the frame rails of the frame 12 when the torque box 300 is in a position to be releasably coupled to the frame 12. In some embodiments, the inside surface of each of the second outer plates 374 is configured to interface with (e.g., contact, etc.) the outside surface of one of the frame rails of the frame 12 when the torque box 300 is in a position to be releasably coupled to the frame 12. In other embodiments, the inside surface of each of second outer plates 374 is configured to be spaced apart from (e.g., have a gap between, not contact, etc.) the outside surfaces of the frame rails of the frame 12 when the torque box 300 is in a position to be releasably coupled to the frame 12.

As shown in FIGS. 9, each of the second lower brackets 373 defines at least one first aperture (e.g., holes, slots, etc.), shown as third mounting aperture 378, positioned along each of the second inner plates 376. As shown in FIGS. 7, 9, and 10, each of the second outer plates 374 defines at least one second aperture, shown as fourth mounting apertures 379, positioned along each of the second outer plates 374 and configured to align with one of the third mounting aperture 378. According to the exemplary embodiment shown in FIGS. 7, 9, and 10, each of the third mounting apertures 378 and the fourth mounting apertures 379 have a circular shape. In other embodiments, each of the third mounting apertures 378 and the fourth mounting apertures 379 has a non-circular shape. (e.g., rectangular, square, oval, octagon, hexagon, etc.). In some embodiments, each of the second lower brackets 373 defines a plurality of the third mounting apertures 378 and a plurality of fourth mounting apertures 379. In such embodiments, (a) the third mounting apertures 378 and the fourth mounting apertures 379 may all have the same shape or (b) at least one of the third mounting apertures 378 and the fourth mounting apertures 379 may have a first shape (e.g., rectangular), and at least one of the third mounting apertures 378 and the fourth mounting apertures 379 may have a second, different shape (e.g., circular).

As shown in FIG. 9, the frame 12 defines a second plurality of apertures, shown as second receiving apertures 382, positioned along the webbing of the longitudinal frame rails of the frame 12 and configured to align with the third mounting apertures 378 and the fourth mounting apertures 379 when the torque box 300 is in a position to be releasably coupled to the frame 12. According to an exemplary embodiment, each of the second receiving apertures 382 is configured to have a shape that is the same or similar to the third mounting apertures 378 and the fourth mounting apertures 379.

As shown in FIG. 9, the third mounting apertures 378, the fourth mounting apertures 379, and the second receiving apertures 382 align to selectively receive a second plurality of couplers (e.g., pins, shafts, mandrels, connectors, non-bolt couplers or connectors, non-threaded couplers or connectors, etc.), shown as second mounting pins 384, to releasably couple the second lower brackets 373 to the longitudinal frame rails of the frame 12 and, thereby, the torque box 300 to the frame 12. According to an exemplary embodiment, the second mounting pins 384 have a cross-sectional shape that corresponds with the shape of the third mounting apertures 378, the fourth mounting apertures 379, and the second receiving apertures 382. According to the exemplary embodiment shown in FIGS. 7, 9, and 10, each of the second mounting pins 384 has a circular cross-section shape. Such cylindrical pins may have a diameter between about one inch and about five inches (e.g., at least 1.0 inch, at least 1.5 inches, at least 2.0 inches, at least 2.5 inches, at least 3.0 inches, at least 3.5 inches, at least 4.0 inches, at least 4.5 inches, at least 5.0 inches, etc.). In other embodiments, each of the second mounting pins 384 has a non-circular cross-sectional shape (e.g., rectangular, square, hexagon, octagon, oval, etc.). In some embodiments (e.g., in embodiments where each of the second lower brackets 373 defines a plurality of the third mounting apertures 378 and a plurality of the fourth mounting apertures 379, and each frame rail of the frame 12 defines a plurality of the second receiving apertures 382), each of the second lower brackets 373 is coupled to the frame 12 using a plurality of the second mounting pins 384 (e.g., two, three, etc. of the second mounting pins 384 rather than a single one of the second mounting pins 384 as shown in FIGS. 7, 9, and 10). In such embodiments, at least one of the second mounting pins 384 may have a first cross-sectional shape (e.g., rectangular), and at least one of the second mounting pins 384 may have a second, different cross-sectional shape (e.g., circular). In some embodiments, the second mounting pins 384 are different than the first mounting pins 352 (e.g., a different cross-sectional shape). In some embodiments, the second mounting pins 384 are the same as the first mounting pins 352.

According to an exemplary embodiment, each of the second mounting pins 384 include a flared end (e.g., a second flared end, etc.) similar to the flared ends 353 of the first mounting pins 352. The flared ends of the second mounting pins 384 may have a larger cross-section than the fourth mounting apertures 379 and are configured to engage with the outer surface of the second outer plates 374 to prevent the second mounting pins 384 from fully passing through the fourth mounting apertures 379 when the second mounting pins 384 are inserted into the third mounting apertures 378, the fourth mounting apertures 379, and the second receiving apertures 382 to couple the torque box 300 to the frame 12. In other embodiments, the flared ends of the second mounting pin 384 have a larger cross-section that the second receiving apertures 382 of the frame 12 and are configured to engage with the inner surface of the frame rails of the frame 12 to prevent the second mounting pins 384 from fully passing through (e.g., drifting through, fitting within, etc.) the frame rails of the frame 12 when the second mounting pins 384 are inserted into the third mounting apertures 378, the fourth mounting apertures 379, and the second receiving apertures 382 to couple the torque box 300 to the frame 12. In other embodiments, the flared ends of the second mounting pin 384 have a larger cross-section than the third mounting apertures 378 and are configured to engage with the inner surface of the second inner plates 376 to prevent the second mounting pins from fully passing through the third mounting apertures 378 when the second mounting pins 384 are inserted into the third mounting apertures 378, the fourth mounting apertures 379, and the second receiving apertures 382 to couple the torque box 300 to the frame 12 (e.g., when the frame rails of the frame 12 are positioned between the first outer plates 344 and the first inner plates 346, etc.).

In still other embodiments, each of the second mounting pins 384 include a first of the flared ends on a first end of the second mounting pin 384 and a second of the flared ends on a second opposing end of the first mounting pins 352. The first of the flared ends have a larger cross-section than the fourth mounting apertures 379 and are configured to engage with the outer surface of the second outer plates 374 to prevent the second mounting pins 384 from fully passing through the second outer plates 374 when the second mounting pins 384 are inserted into the third mounting apertures 378, the fourth mounting apertures 379, and the second receiving apertures 382 to couple the torque box 300 to the frame 12. The second of the flared ends have a larger cross-section than second receiving apertures 382 of the frame 12 and are configured to engage with the inner surface of the frame rails of the frame 12 to prevent the second mounting pins 384 from fully passing through the frame rails of the frame 12 when the second mounting pins 384 are inserted into the third mounting apertures 378, the fourth mounting apertures 379, and the second receiving apertures 382 to couple the torque box 300 to the frame 12. In some embodiments, the second mounting pins 384 do not include the flared ends.

According to an exemplary embodiment, a bushing (e.g., sheath, liner, etc.) similar to the adjustment bushing 358 is positioned between at least one of the second mounting pins 384 and at least one of the second receiving apertures 382 when the second mounting pins 384 couple the torque box 300 to the frame 12. In some embodiments, a respective adjustment bushing is positioned between each set of the second mounting pins 384 and the second receiving apertures 382. The bushings are configured to accommodate some misalignment between each of the third mounting apertures 378 and the second receiving apertures 382 when the torque box 300 is in a position to be releasably coupled to the frame 12. In some embodiments, the adjustment bushings are additionally or alternatively positioned (a) between each of the second mounting pins 384 and the third mounting apertures 378 and/or (b) between each of the second mounting pins 384 and the fourth mounting apertures 379. According to an exemplary embodiment, each of the bushings defines a bushing aperture similar to the first bushing apertures 359 and centered on the axis of the bushings. In other embodiments, the bushing apertures are offset from the axis of the bushings in order to accommodate some misalignment between the third mounting apertures 378 and the second receiving apertures 382 when the torque box 300 is in a position to be releasably coupled to the frame 12.

According to the exemplary embodiment shown in FIG. 9, a plurality of retaining members (e.g., brackets, retainers, securing members, etc.), shown as second retainers 385, are positioned to interface with a free end of each of the second mounting pins 384. When the second mounting pins 384 are coupling the torque box 300 and the frame 12, each of the second retainers 385 releasably engages the free end of one of the second mounting pins 384 and is secured thereto using one or more fasteners (e.g., bolts, screws, pins, etc.), shown as second retainer fasteners 386. The second retainers 385 are configured to engage with the inner surface of the frame rails of the frame 12 or the outer surface of the second outer plate 374 to prevent the incidental removal of the second mounting pins 384 from the third mounting apertures 378, the fourth mounting apertures 379, and the second receiving apertures 382. In other embodiments, one or more of the second mounting pins 384 is held in position using a different form of fastener or retainer (e.g., clevis pins, cotter pins, linch pins, retaining nuts, castle nuts, etc.) and/or other means (e.g., friction, press fit, etc.). For example, the second mounting pins 384 may be held in positioned using any of the retainers shown in FIGS. 16-22.

Traditionally, torque boxes have been coupled to frames of fire trucks using a plurality of bolts. Due to the high loads between the torque box and the frame while using an aerial assembly, there must be a significant quantity of bolts (e.g., greater than 20 bolts, 32 bolts, etc.) to couple the torque box to the frame. All of these bolts must be inspected frequently (e.g., annually) for tightness or torque (e.g., using a toque wrench) and all the bolts must be removed when the torque box and aerial assembly have to be removed from the fire truck. The bolts are often located under the fire truck in areas that are difficult to access, which increases the inspection and maintenance time of the fire truck and associated costs for such inspection and maintenance, as well as results in additional time that the fire truck is not operational. In some instances, the positioning of the bolts can make is difficult to accurately inspect the torque thereof and, in some instances, the torque of the bolts may not even be inspected due to difficulty. Removing all of such bolts and replacing them with a limited number of pins (e.g., six pins, four pins, etc.) as described herein provides various advantages. First, the number of components that need to be inspected is significantly reduced. Second, pins support shear loading and do not have to support clamp loads, whereas the bolts have to support both shear load and clamp loading (through threaded engagement), which requires such extensive torque inspection. Third, to inspect the pins only requires confirming that the pins are still present and that the retainers (e.g., retaining pins, retaining nuts, retaining bolts, retaining rings, retaining washers, etc.) are secured thereto to prevent removal thereof. Accordingly, the pins and retainers described herein are non-clamping, and in some instances non-threaded, such that the pins provide “clamp-less” load transfer between the torque box 300 and the frame 12.

A pinned connection (e.g., a first pinned connection, a second pinned connection, a third pinned connection, a fourth pinned connection, etc.), according to an exemplary embodiment, attaches a torque box (e.g., torque box 300, etc.) to a frame (e.g., frame 12, etc.). In one embodiment, a pinned connection couples two components without applying a clamp load therebetween (e.g., the load formed as part of a bolted connection as the nut is tightened on the bolt, etc.). In another embodiment, the pinned connection couples two components without sufficient clamp load therebetween (e.g., without a clamp load that would be required for the connection per applicable standards and approaches for calculating the same, etc.). A pinned connection may include couplers (e.g., pins, retainers, etc.). The coupler may be an elongated component, and apertures configured to receive the coupler may be formed in the joined components. The coupler, in one embodiment, couples a torque box to a frame with a “clamp-less” connection such that (a) shear load is carried by the coupler and (b) zero or an insufficient clamping force is provided by the coupler. In another embodiment, the coupler couples a torque box to a frame with shear loading applied thereto. In contrast to a pinned connection, a bolted connection is formed by a bolt and a nut, where the nut is threaded onto the bolt and tightened against a component to elongate (e.g., stretch, etc.) the bolt (which may be in contact with a second component). The spring force applied by the elongated bolt produces a clamp load that reduces (e.g., eliminates, etc.) movement between the two components. Friction resists relative movement between the two components such that the bolted connection carries loading, including shear loading. Bolts may be sized smaller than the aperture relative to couplers received in the same sized bore. In some embodiments, couplers are designed and sized within much tighter tolerances (e.g., thousandths of an inch) than bolts, thereby preventing relative movement between two components and carrying the shear load (e.g., without providing a clamping force between two objects). A bolt and nut sized and/or torqued to function similar to the couplers described herein should be understood as providing a “clamp-less” or “pinned” connection if the bolt and nut are not tightened to the point of providing a clamping force to a frame and a torque box that is sufficient to increase or alter engagement between the frame and the torque box relative to when the bolt and nut connection is removed even though the nut and the head of the bolt may engage (e.g., touch, apply some load to, etc.) the frame and torque box.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Language such as the phrase “at least one of X, Y, and Z” and “at least one of X, Y, or Z,” unless specifically stated otherwise, is understood to convey that an element may be either X; Y; Z; X and Y; X and Z; Y and Z; or X, Y, and Z (i.e., any combination of X, Y, and Z). Thus, such language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the fire apparatus 10 and the systems and components thereof as shown in the various exemplary embodiments is illustrative only. Additionally, any element disclosed in one embodiment may be incorporated or utilized with any other embodiment disclosed herein.

1. A fire apparatus comprising:
a chassis including a first frame rail and a second frame rail, each frame rail of the first frame rail and the second frame rail defining one or more first apertures and one or more second apertures;
a torque box disposed along the chassis, the torque box having a first end and an opposing second end;
an aerial assembly supported by the torque box;
a first mounting assembly coupled to the first end of the torque box, the first mounting assembly including a first mount coupled to a first side of the torque box and a second mount coupled to an opposing second side of the torque box, each of the first mount and the second mount defining one or more third apertures, the one or more third apertures positioned to align with the one or more first apertures;
a second mounting assembly coupled to the opposing second end of the torque box, the second mounting assembly including a third mount coupled to the first side of the torque box and a fourth mount coupled to the opposing second side of the torque box, each of the third mount and the fourth mount defining one or more fourth apertures, the one or more fourth apertures positioned to align with the one or more second apertures;
a first plurality of pins extending through (a) the one or more first apertures of the first frame rail and the one or more third apertures of the first mount and (b) the one or more first apertures of the second frame rail and the one or more third apertures of the second mount; and
a second plurality of pins extending through (a) the one or more second apertures of the first frame rail and the one or more fourth apertures of the third mount and (b) the one or more second apertures of the second frame rail and the one or more fourth apertures of the fourth mount.

2. The fire apparatus of claim 1, wherein the first plurality of pins and the second plurality of pins couple the torque box to the chassis with a clamp-less connection.

3. The fire apparatus of claim 1, wherein at least one of the first plurality of pins has a first flared end with a larger cross-section than at least one of the one or more first apertures or the one or more third apertures.

4. The fire apparatus of claim 3, further comprising a retainer coupled to a free end of the at least one of the first plurality of pins opposing the first flared end, the retainer positioned to engage the first frame rail, the second frame rail, the first mount, or the second mount to prevent incidental removal of the at least one of the first plurality of pins.

5. The fire apparatus of claim 3, further comprising a fastener positioned to interface with the first flared end of the at least one of the first plurality of pins to secure the first flared end to the first frame rail, the second frame rail, the first mount, or the second mount.

6. The fire apparatus of claim 1, wherein at least one of the first plurality of pins includes a first flared end with a larger cross-section than at least one of the one or more first apertures and a second flared end opposing the first flared end, the second flared end having a larger cross-section than at least one of the one or more third apertures.

7. The fire apparatus of claim 1, further comprising a pair of retainers coupled to opposing ends of at least one of the first plurality of pins, wherein (a) a first retainer of the pair of retainers is positioned to engage the first frame rail and (b) a second retainer of the pair of retainers is positioned to engage the first mount to prevent incidental removal of the at least one of the first plurality of pins.

8. The fire apparatus of claim 1, wherein:
the first mount includes:
a first plate defining the one or more third apertures; and
a second plate defining one or more fifth apertures, the one or more fifth apertures positioned to align with the one or more third apertures; and
at least one of the first plurality of pins extends through the one or more first apertures of the first frame rail, the one or more third apertures of the first plate, and the one or more fifth apertures of the second plate.

9. The fire apparatus of claim 8, wherein the first frame rail is positioned between the first plate and the second plate.

10. The fire apparatus of claim 8, wherein the first plate is positioned between the first frame rail and the second plate.

11. The fire apparatus of claim 1, further comprising a bushing positioned between (a) at least one of the first plurality of pins and (b) at least one of the (i) one or more first apertures of the first frame rail or (b) the one or more third apertures of the first mount.

12. The fire apparatus of claim 11, wherein the at least one of the first plurality of pins extends through a bushing aperture defined by the bushing, wherein the bushing aperture is offset from a central axis of the bushing.

13. The fire apparatus of claim 1, wherein at least one of the first plurality of pins has a first cross-sectional shape and at least one of the second plurality of pins has a second cross-sectional shape that is different from the first cross-sectional shape.

14. The fire apparatus of claim 1, wherein at least one of the first plurality of pins has a first cross-sectional shape and at least one of the second plurality of pins has a second cross-sectional shape that is the same as the first cross-sectional shape.

15. A fire apparatus comprising:
a chassis including a first frame rail and a second frame rail;
a torque box disposed along the chassis, the torque box having a first end and an opposing second end;
an aerial assembly supported by the torque box;
a first mounting assembly positioned proximate the first end of the torque box, the first mounting assembly including a first mount coupled to a first side of the torque box and a second mount coupled to an opposing second side of the torque box;
a second mounting assembly positioned proximate the opposing second end of the torque box, the second mounting assembly including a third mount coupled to the first side of the torque box and a fourth mount coupled to the opposing second side of the torque box;
a first pinned connection coupling the first frame rail and the first mount;
a second pinned connection coupling the second frame rail and the second mount;
a third pinned connection coupling the first frame rail and the third mount; and
a fourth pinned connection coupling the second frame rail and the fourth mount.

16. The fire apparatus of claim 15, wherein the first pinned connection includes a pin extending through the first frame rail and the first mount.

17. The fire apparatus of claim 16, wherein:
the pin has a first pin end and an opposing second pin end;
the first pinned connection includes a first retainer positioned at or proximate the first pin end;
the first pinned connection includes a second retainer positioned at or proximate the opposing second pin end; and
the first retainer is positioned to engage the first frame rail and the second retainer is positioned to engage the first mount to prevent incidental removal of the pin.

18. The fire apparatus of claim 17, wherein at least one of the first retainer or the second retainer is fixedly coupled to the pin.

19. The fire apparatus of claim 17, wherein at least one of the first retainer or the second retainer is releasably coupled to the pin.

20. A chassis for a fire apparatus, the chassis comprising:
a first frame rail defining a first aperture;
a second frame rail defining a second aperture; and
a torque box assembly disposed along the first frame rail and the second frame rail, the torque box assembly including:
a torque box; and
a mounting assembly releasably coupling the torque box to the first frame rail and the second frame rail, the mounting assembly including:
a first plate defining a third aperture;
a second plate spaced from the first plate and defining a fourth aperture;
a third plate defining a fifth aperture;
a fourth plate spaced from the third plate and defining a sixth aperture;
a first pinned connection engaging with the first aperture, the third aperture, and the fourth aperture; and
a second pinned connection engaging with the second aperture, the fifth aperture, and the sixth aperture.
